(19) United States
(12) Patent Application Publication
(10) Pub. No.: US 2026/0065348 A1
(43) Pub. Date: Mar. 5, 2026

(54) SYSTEM AND METHOD FOR AUTOMATED HAIR ANALYSIS AND PRODUCT RECOMMENDATIONS

(71) Applicants: Dereck Hatcher, Novato, CA (US); Michael Learo, San Diego, CA (US)

(72) Inventors: Dereck Hatcher, Novato, CA (US); Michael Learo, San Diego, CA (US)

(21) Appl. No.: 19/313,984

(22) Filed: Aug. 29, 2025

Related U.S. Application Data
(60) Provisional application No. 63/688,781, filed on Aug. 29, 2024.

(51) Int. Cl. G06Q 30/0601; A45D 44/00; G06Q 30/0273; G06Q 30/0282; G06V 10/82; G06V 40/10

(52) U.S. Cl. CPC G06Q 30/0631; A45D 44/005; G06Q 30/0275; G06Q 30/0282; G06V 10/82; G06V 40/10; A45D 2044/007

(57) ABSTRACT

Hair analysis systems are disclosed. The systems include a server and a processor that are configured to receive a digital image of a subject's hair. The system is configured to identify a hair classification of the subject's hair based on the digital image and communicate the hair classification to the subject. The system is further configured to communicate one or more recommendations to the subject. The one or more recommendations identify one or more hair care products that are optimized for the subject's hair classification.

### CROSS-REFERENCE TO RELATED APPLICATIONS

This application claims priority to, and incorporates by reference, U.S. provisional patent application Ser. No. 63/688,781, filed on Aug. 29, 2024.

### FIELD OF THE INVENTION

The field of the present invention relates to hair analysis systems, including hardware and software that are configured to image, analyze, and provide data and recommendations regarding human hair and scalp health.

### BACKGROUND OF THE INVENTION

The global hair and scalp care market has been reported to be valued at over 80 billion dollars. Indeed, for many years, businesses have been developing, optimizing, and selling hair and scalp care products that are described to be tailored for various types of hair and scalp conditions. Such types of hair include, e.g., straight hair, curly hair, thick hair, thin hair, color-specific attributes (i.e., blonde versus brunette), and many others. Likewise, hair care products have been developed that are designed to treat and/or prevent various scalp conditions, such as dry scalp conditions.

In most cases, consumers try to identify suitable hair care products themselves, largely based on their own assessment of hair type and what they believe to be an appropriate hair care product. It would be desirable to provide a system that objectively and even quantitatively assesses hair types and scalp conditions—and, moreover, identifies suitable hair care products based on such assessment.

As the following will demonstrate, the inventions described herein address such demands in the marketplace (as well as many others).

### SUMMARY OF THE INVENTION

According to certain aspects of the present invention, hair analysis systems are provided, which generally include a server and a processor that are configured to receive a digital image of a subject's hair and scalp. In certain embodiments, the system is configured to calculate and identify a hair classification of the subject's hair based on the digital image and communicate the hair classification to the subject. The system is further configured to communicate one or more recommendations to the subject. The one or more recommendations identify one or more hair care products that are optimized for the subject's hair classification. The system further comprises a database and a data storage facility that are configured to receive, record, and make accessible to the subject (and other users of the system) the digital image, hair classification, the one or more recommendations communicated to a subject, and other subject-specific information.

According to such aspects of the invention, the hair classification is selected by the system from a plurality of predefined hair classification options.

The invention provides that the hair analysis system may be further configured to identify a second digital image (or multiple additional images) that the subject may, optionally, capture and transmit to the system for analysis (e.g., when the system determines that a first digital image is not optimal or sufficient for a complete analysis). In addition, the system is configured to communicate the one or more recommendations for hair care products to the subject based not only on the applicable hair classification, but also the geographical location, weather conditions, demographic data, subject profile information, and/or other details that pertain to the subject.

The invention provides that the hair analysis system may be configured to communicate the one or more recommendations to the subject based further on feedback submitted to the system from third-party subjects having hair classifications that match (or that closely resemble) the hair classification of the subject, i.e., the system is preferably configured to undertake machine learning and artificial intelligence techniques based on a growing body of data and feedback submitted by subjects (such feedback may include, e.g., scores, ratings, and other assessments submitted by the third-party subjects regarding the one or more recommended hair care products). The hair analysis system may further encompass a computing device that is configured to capture the digital image; transmit the digital image to the system; receive and display the calculated hair classification to the subject; and receive and display the one or more recommendations to the subject.

According to related aspects of the invention, the system may be configured to employ machine learning and artificial intelligence to perform certain data augmentation techniques, namely, to prepare a set of images - or multiple sets of images—for training a deep learning model to be used by the system of the present invention. In such embodiments, the system may be configured to create variations of each subject image by automatically resizing each image, applying a random rotation of up to 10-degrees, and constantly adjusting the brightness and contrast filters applied to such images. Such data augmentation procedures will benefit the system of the present invention by artificially expanding the dataset of hair images, which helps the final model generalize better-to-new, unseen images. After such augmentations, the system is preferably configured to normalize a base image's pixel values using standard ImageNet statistics, provided that such normalization step should be applied after all other data augmentation steps have been completed.

According to such aspects of the present invention, the hair care products recommended by the system include shampoos, conditioners, gels, oils, coloring agents, sprays, vitamins, minerals, and/or other hair and dermatological products that are suitable for the subject's hair classification. In certain embodiments, such hair care products are selected and identified by the system from a plurality of optional hair care products, with the plurality of optional hair care products being provided by third-party merchants. The invention provides that such third-party merchants may submit a fee to the system to have its hair care products listed within the plurality of optional hair care products. Alternatively, in other embodiments, the third-party merchants may submit bids to the system to have its hair care products listed within the plurality of optional hair care products.

The above-mentioned and additional features of the present invention are further illustrated in the Detailed Description contained herein.

### BRIEF DESCRIPTION OF THE DRAWINGS

FIG. 1 is a diagram showing the various components of the hair analysis system described herein.

FIG. 2 is a diagram showing the centralized nature of the hair analysis system and its ability to simultaneously service multiple users/subjects.

FIG. 3 is a diagram showing a digital image of a hair sample.

FIG. 4 is a diagram showing an excerpted portion of the digital image of FIG. 3.

FIG. 5 is a diagram showing a focused and zoomed view of the pixels that comprise a subset of the excerpted portion of the digital image of FIG. 4.

FIG. 6 is a diagram showing how the radius of curvature may be calculated for a hair strand type that exhibits significant curl.

FIG. 7 is a diagram showing how the radius of curvature may be calculated for a hair type that exhibits less curl (relative to the hair strand shown in FIG. 6).

FIG. 8 is a diagram showing how the radius of curvature may be calculated.

FIG. 9 is a diagram showing how the average hair density rating, average hair curvature rating, and average hair color rating may be plotted within a cartesian plane to calculate a hair classification.

FIG. 10 is a diagram showing how an algorithm, along with the average hair density rating, average hair curvature rating, and average hair color rating, may be used to calculate a hair classification.

FIG. 11 is a diagram showing how multiple subject-specific variables are stored and considered by the system when calculating and communicating one or more recommendations for hair care products.

FIG. 12 is a diagram showing how multiple product-specific variables are stored and considered by the system when calculating and communicating one or more recommendations for hair care products.

FIG. 13 is a diagram showing an excerpted and zoomed-in portion of a digital image of a subject's scalp.

FIG. 14 is a diagram showing the relationship of the various computing modules discussed in the Example below.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

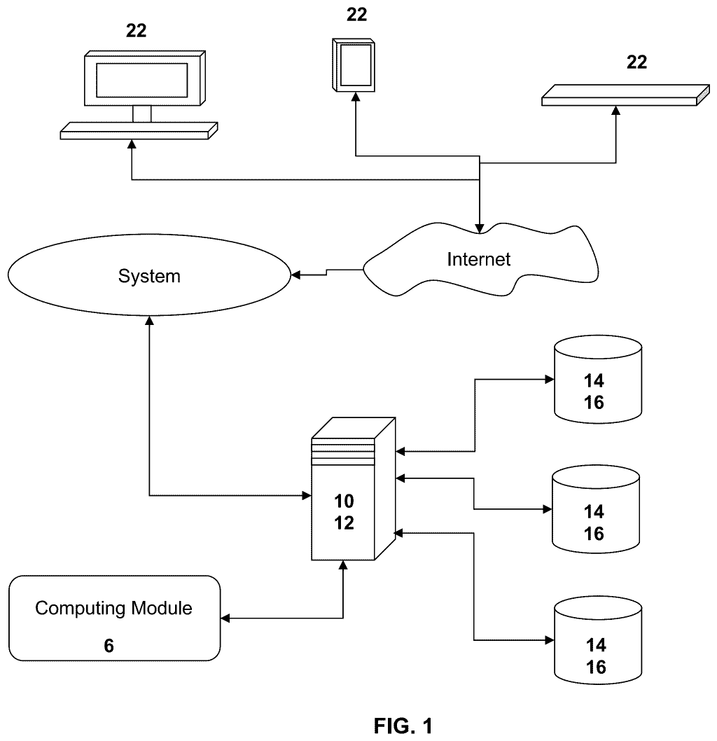

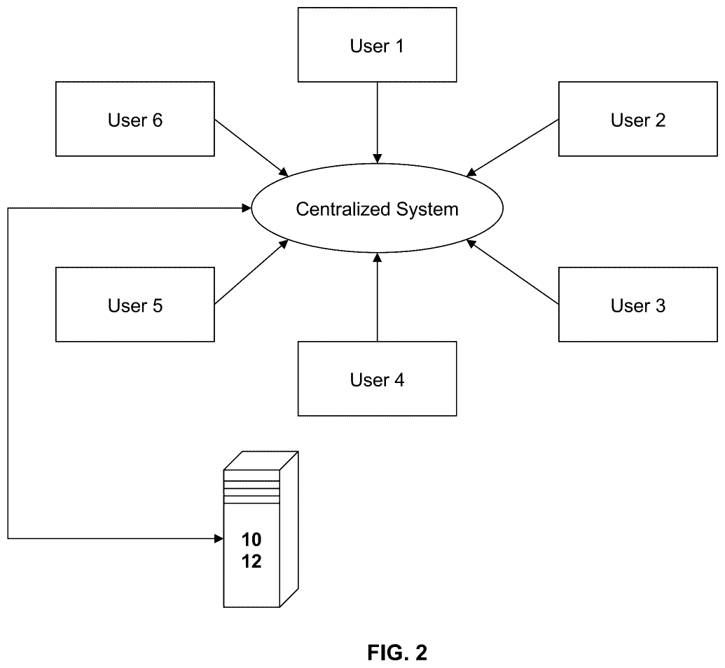

Referring now to FIG. 1-14, according to certain preferred embodiments of the present invention, hair analysis systems are provided, which generally include a server 10 and a processor 12 that are configured to receive a digital image of a subject's hair. The system is configured to identify a hair classification of the subject's hair based on the digital image and communicate the hair classification to the subject. The invention provides that the server 10 and processor 12 may be dedicated to the systems described herein or, in other embodiments, may exist within a scalable server cloud environment maintained by third parties, such as those provided by Google, Amazon Web Services (AWS), and others. The invention provides that the hair analysis system is preferably configured to receive digital images, and conduct the hair analysis described herein, from multiple subjects/users at the same time, i.e., the server 10 and processor 12 form a part of a centralized system that may be operated, simultaneously, among multiple subjects/users (FIG. 2). Any of a variety of devices 22 that are configured to capture a digital image of a subject's hair may be used with (and/or may constitute a component of) the hair analysis system, such as computers, mobile phones, tablets, and other devices (FIG. 1).

According to certain preferred embodiments, the hair analysis system of the present invention is further configured to calculate and communicate one or more recommendations for hair products to the subject. More particularly, the invention provides that the one or more recommendations will identify one or more hair care products that are optimized for the subject's hair classification. The system further comprises one or more databases 14 and data storage facilities 16 that are configured to receive, record (store), and make accessible to each subject the correlated digital images, hair classifications, and applicable one or more recommendations for hair care products.

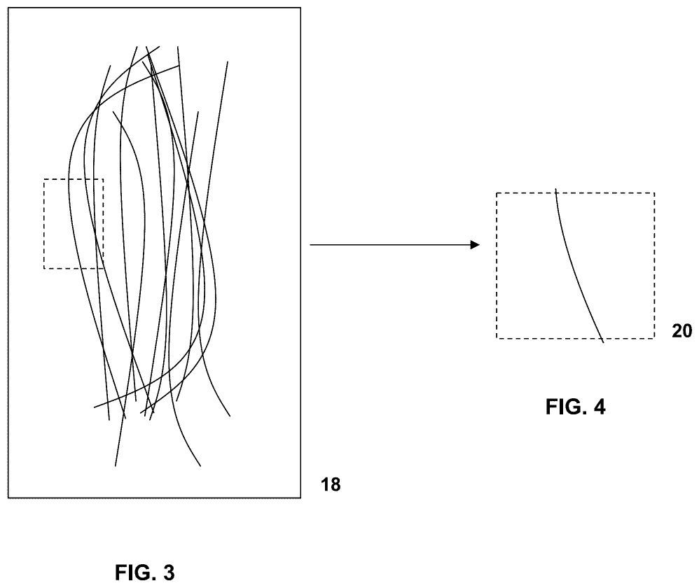

According to such preferred embodiments of the present invention, the hair classification is preferably selected by the system from a plurality of predefined hair classification options. More particularly, referring to FIG. 3, the system is preferably configured to automatically focus on a subset 18 of a digital image of a subject's hair. In some embodiments, the subset 18 of a digital image of a subject's hair is randomly located by the system or, in other embodiments, a subject/user of the system may locate and define the subset 18. Still further, the invention provides that the system may be configured to automatically focus on a plurality of subsets 18 of a digital image of a subject's hair, such that the subsequent analysis and calculations described herein may represent a statistical average, median, or other aggregated statistical data. According to such embodiments, the hair analysis may be configured to further generate a focused excerpt 20 (FIG. 4) of the subset 18 of a digital image of a subject's hair. In such embodiments, the focused excerpt 20 (FIG. 4) of the subject's hair will preferably allow the system to analyze, in more detail, a single or limited number of hair strands. The purpose of the foregoing procedures is to, among other things, reduce or eliminate unwanted “noise” within the image(s) that may otherwise impede or corrupt the calculated hair classification.

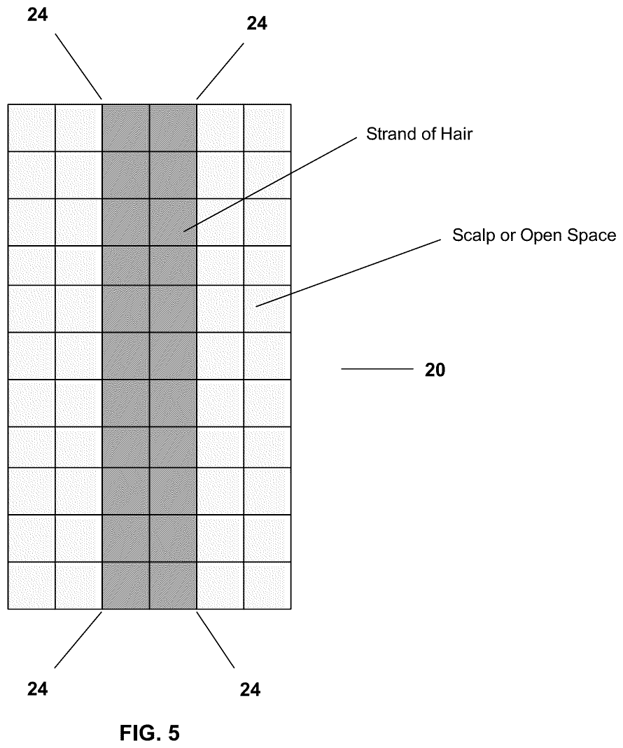

Referring now to FIG. 5, the hair analysis system will preferably be configured to magnify and zoom-into the focused excerpt 20 of the subject's hair, preferably down to individual pixels. The system may be configured to utilize densitometric types of analyses to delineate between a subject's hair strand, scalp, and open space. Such delineation may, for example, identify hair strands—apart from scalp or open spaces—based on differences in pixel colors/densities and the boundaries 24 that are formed between such pixels (FIG. 5). The invention provides that the hair analysis system may be further configured to recommend and/or identify a second digital image (or multiple digital images) that the subject may, optionally, capture and transmit to the system for analysis (e.g., when the system determines that a first digital image is not optimal or sufficient for a complete analysis). Still further, the invention provides that the system may be configured to communicate guidance to a subject, which assists the subject in capturing one or more suitable digital images of the subject's hair and/or scalp to enable the system to calculate a hair classification score. Such guidance may specify one or more locations of the subject's hair that should be captured—as well as camera angles and other guiding information.

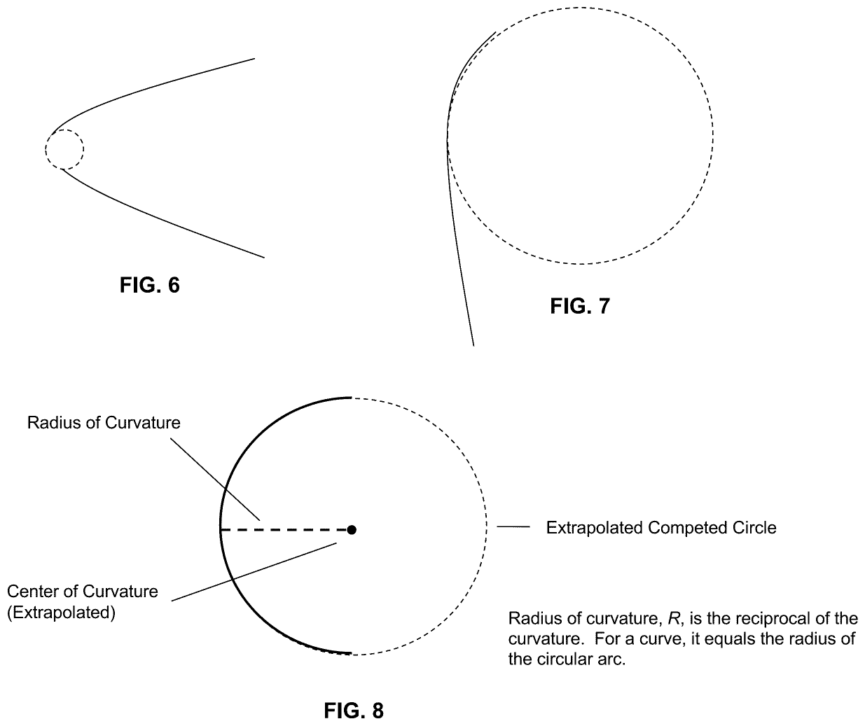

As described above, using the subset 18 of the digital image and its focused excerpt 20, the hair analysis system is configured to calculate and communicate to the subject/user a hair classification. The hair classification may include subjective labels (e.g., curly, semi-curly, straight hair—and—thick, semi-thick, thin hair); the hair classification may also include quantitative and numeric scores (e.g., numeric scores attributed to various hair quality features); or a mix of both subjective labels and numeric scores. For example, referring now to FIGS. 6-8, the hair analysis system may be preferably configured to analyze and calculate the extent to which a subject's hair exhibits curly or straight characteristics. Likewise, based on detected pixel coloration (FIG. 5), the hair analysis system may be preferably configured to analyze and calculate a color score. Still further, for example, the hair analysis system may be preferably configured to analyze and calculate a hair density score (which generally indicates whether a subject has thick or thin hair). As such, the system enables subjects to learn more about their hair and, preferably, receive a hair classification that more quantitatively and precisely defines hair characteristics—which also enables the system to provide matching hair care products with more precision.

For example, referring to FIG. 8, the hair analysis system may be configured to calculate a score associated with the extent to which a subject's hair exhibits curly or straight characteristics. Such a calculation may be achieved by, for example, calculating a radius of curvature for one or more hair strands—and, preferably, calculating an average (or median) radius of curvature for a plurality of hair strands. Such plurality of hair strands may be randomly selected to ensure that the calculation suitably represents the extent to which a subject exhibits curly hair (or some amount of curl along a spectrum of essentially straight hair to very curly hair). As illustrated in FIG. 6-8, the system may be configured to locate a predominate curve within each hair strand being analyzed, and then generate a hypothetical/extrapolated circle that partially aligns with the predominate curve. The radius of curvature can then be calculated based on such hypothetical/extrapolated circle (using mathematical formulas well known in the art). In this example, the radius of curvature (or the average or median radius of curvature among a plurality of hair strands) may be correlated with, or may constitute, a score that indicates the extent to which the subject's hair exhibits curly or straight characteristics.

Similarly, as mentioned above, the system may be configured to analyze and calculate a color score, based on detected pixel coloration (FIG. 5). In addition, as mentioned above, the hair analysis system may be preferably configured to analyze and calculate a hair density score, which generally indicates whether a subject has thick or thin hair (again, along a numeric continuum that enables such determination with more precision). Such hair density score may be calculated, for example, by counting a number of hair strands detected within a defined two-dimensional area, i.e., subjects with thick hair should have more strands detected within the defined two-dimensional area than subjects with thin hair.

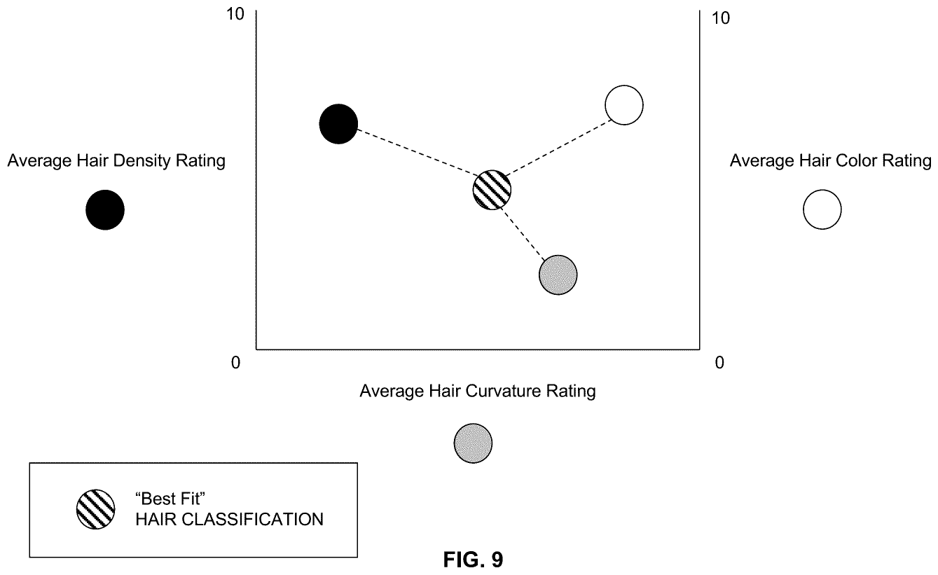

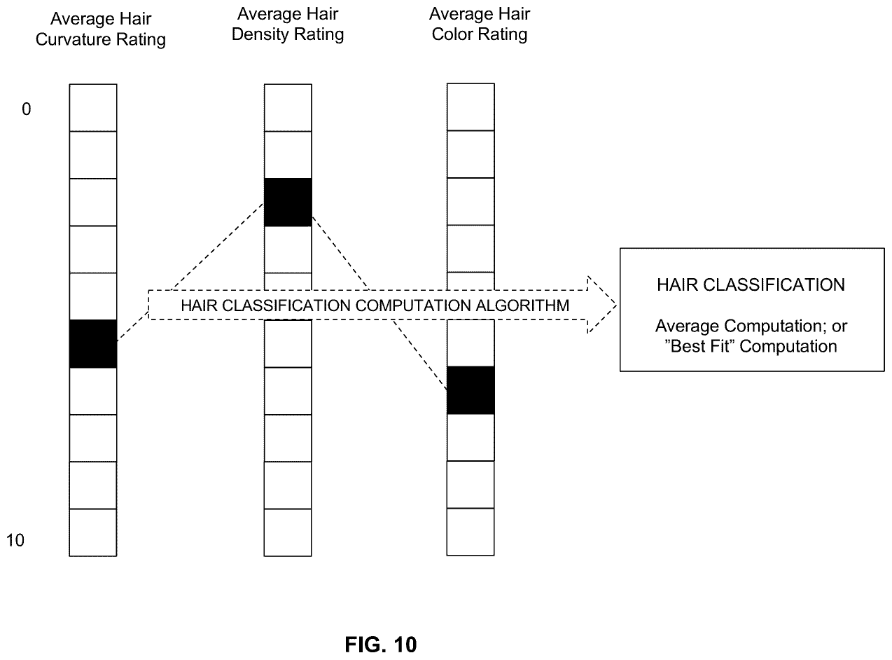

Referring now to FIGS. 9 and 10, the hair analysis system may subsequently utilize the score associated with the extent to which a subject's hair exhibits curly or straight characteristics, a color score, and a density score to compute a hair classification. For example, such scores may be plotted within a cartesian plane (FIG. 9), with the computed hair classification score representing a mathematical “best fit” among those scores. In such embodiments, the invention provides that such scores used as input to compute the hair classification may be attributed the same weight or different weights—e.g., the color score may be weighted the same (or different than) the density score. Referring to FIG. 10, in other embodiments, such individual scores may be used as inputs in an algorithm that produces a hair classification score.

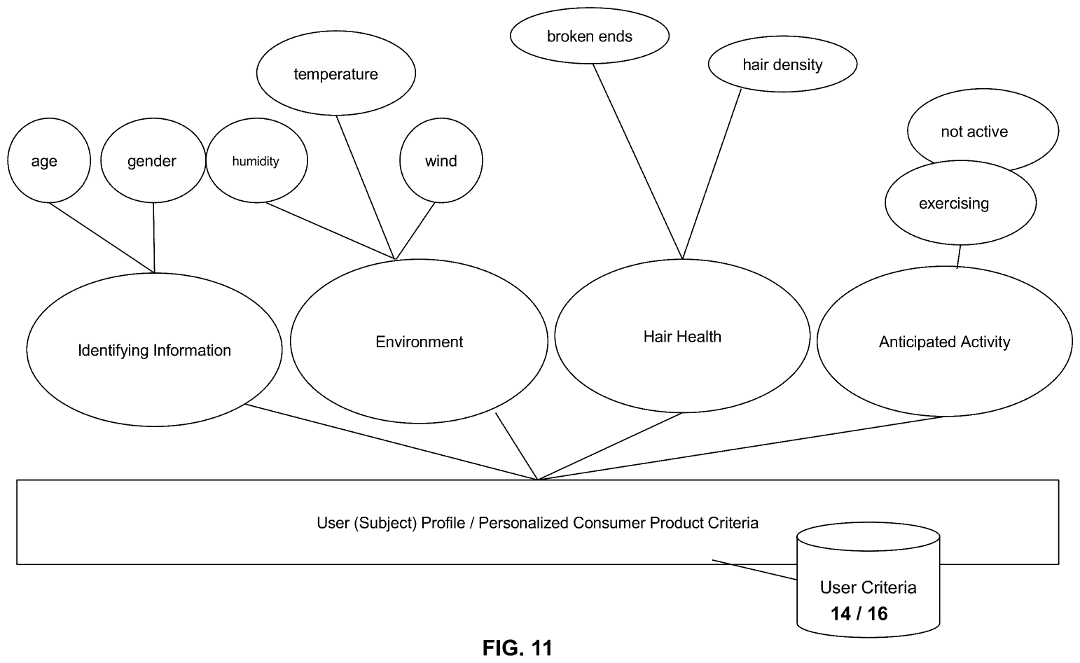

In some embodiments, the invention provides that the hair analysis system is configured to communicate the one or more recommendations for hair care products to the subject based—not only on the applicable hair classification—but also the geographical location, weather conditions, and/or demographic data that pertain to the subject. In other embodiments, such variables (geographical location, weather conditions, demographic data, and others) may be used to calculate the hair classification itself. Referring to FIG. 11, for example, the system and its one or more databases 14 and data storage facilities 16 may receive, record, and make accessible for the purpose of calculating a hair classification and/or making one or more recommendations for hair care products various types of information that a subject may submit to the system (such as through a mobile application and/or website). Such various types of information may include identifying information (age, gender); environmental variables associated with a geographical location in which the subject lives (average humidity, temperature, wind); hair health (a subject's impression of whether his/her hair exhibits broken ends or is thick/thin); and the subject's anticipated activity (i.e., whether the subject routinely exercises or not). The invention provides that such user-specified/subject-specified information and variables may be utilized as inputs by the system to compute the hair classification and/or to make one or more recommendations for hair care products.

The invention provides that the hair analysis system may be configured to communicate the one or more recommendations to the subject based further on feedback submitted to the system from third-party subjects having hair classifications that match (or that closely resemble) the hair classification of the subject, i.e., the system is preferably configured to undertake machine learning and artificial intelligence techniques based on a growing body of data and feedback submitted by subjects (such feedback may include, e.g., scores, ratings, and other assessments submitted by the third-party subjects regarding the one or more recommended hair care products). The hair analysis system may further encompass a computing device 22 that is configured to capture the digital image; transmit the digital image to the system server 10; receive and display the hair classification to the subject; and receive and display the one or more recommendations for hair care products to the subject.

According to such embodiments of the present invention, as mentioned above, the system may be configured to employ machine learning and artificial intelligence, particularly for performing certain data augmentation techniques to prepare a set of images—or multiple sets of images—for training a deep learning model to be used by the system of the present invention. In such embodiments, the system may be configured to create variations of each subject hair image by automatically resizing each image, applying a random rotation of up to 10-degrees, and constantly adjusting the brightness and contrast filters applied to such images. Such data augmentation procedures will benefit the system of the present invention by artificially expanding the dataset of hair images, which helps the final model generalize better-to-new, unseen images. After such augmentations, the system is preferably configured to normalize a base image's pixel values using standard ImageNet statistics, provided that such normalization step should be applied after all other data augmentation steps have been completed.

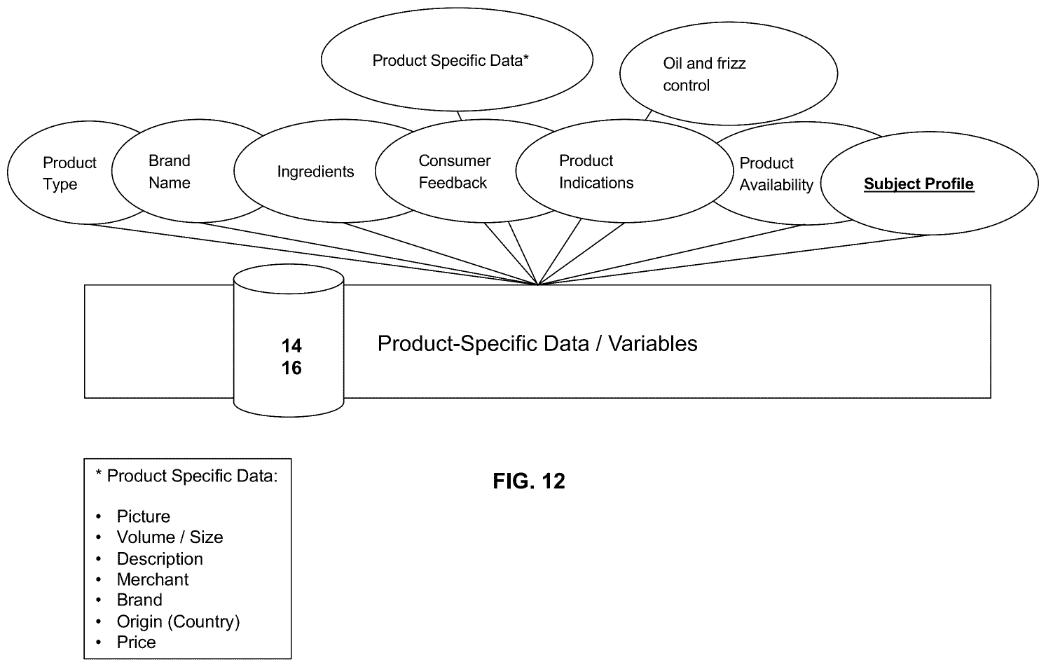

As discussed above, according to such preferred embodiments of the present invention, the hair analysis system will utilize the hair classification score to then provide and communicate one or more recommendations to the subject for specific hair care products. Such hair care products may include shampoos, conditioners, gels, oils, coloring agents, sprays, vitamins, minerals, and/or other hair and dermatological products that are suitable for the subject's hair classification. Referring to FIG. 12, the one or more databases 14 and data storage facilities 16 may receive, record, and make accessible for the purpose of calculating such recommendations various types of information associated with each hair care product. More particularly, the system will maintain a correlation table that lists each hair classification score and one or more hair care products that are optimized for each such hair classification score. The system may further store and communicate to subjects various types of information associated with each product, such as product images, product descriptions, manufacturer (merchant) information, brand names, place of manufacture, pricing information, ingredients, product indications (i.e., how a product is marketed), product availability, product reviews, and other relevant information.

In certain embodiments, the hair care products recommended by the hair analysis system are selected and identified from a plurality of optional hair care products, with the plurality of optional hair care products being provided by third-party merchants. The invention provides that such third-party merchants may submit a fee to the system to have its hair care products listed within the plurality of optional hair care products. Alternatively, in other embodiments, the third-party merchants may submit bids to the system to have its hair care products listed within the plurality of optional hair care products. In such alternative embodiments, the merchants may also bid for product placement, i.e., first, second, third, etc. within a list of recommended hair care products. According to still further embodiments of the present invention, when the system computes and communicates its one or more recommendations to the subject for specific hair care products, it may further provide links to websites and other on-line stores in which such products may be purchased.

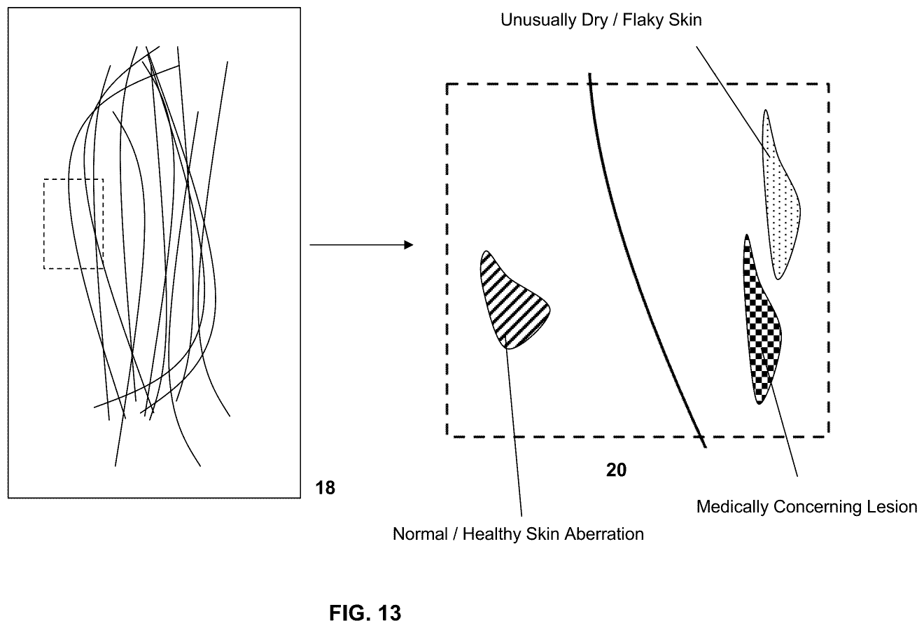

In addition to hair classifications, the invention provides that the system described herein may be configured and utilized to examine scalp conditions. For example, one or more digital images of a subject's scalp may be captured and transmitted to the system. The system may be configured to identify any of various scalp conditions for which potentially helpful products exist, e.g., scalps with insufficient hydration (dry scalps) and/or other dermatological conditions (including potential skin aberrations that should be examined by a physician). Referring to FIG. 13, for example, upon receiving a digital image of a subject's scalp, the system may be configured to generate a subset 18 of the digital image and its focused excerpt 20, as described above in relation to hair analysis. The system may be trained—using previous data sets of subject scalps—to search for, identify, and distinguish between healthy/normal scalp aberrations and problematic aberrations (such as unusually dry areas, oily areas, or potentially cancerous lesions).

The hair analysis system of the present invention offers significant advantages by automating and personalizing the hair care product selection process. It eliminates the guesswork and inefficiencies associated with traditional methods, ensuring subjects/users receive product recommendations that are precisely tailored to their unique hair type and needs. As a result, the hair analysis system greatly enhances the effectiveness of hair care products and routines, thereby promoting healthier and more beautiful hair.

### EXAMPLE

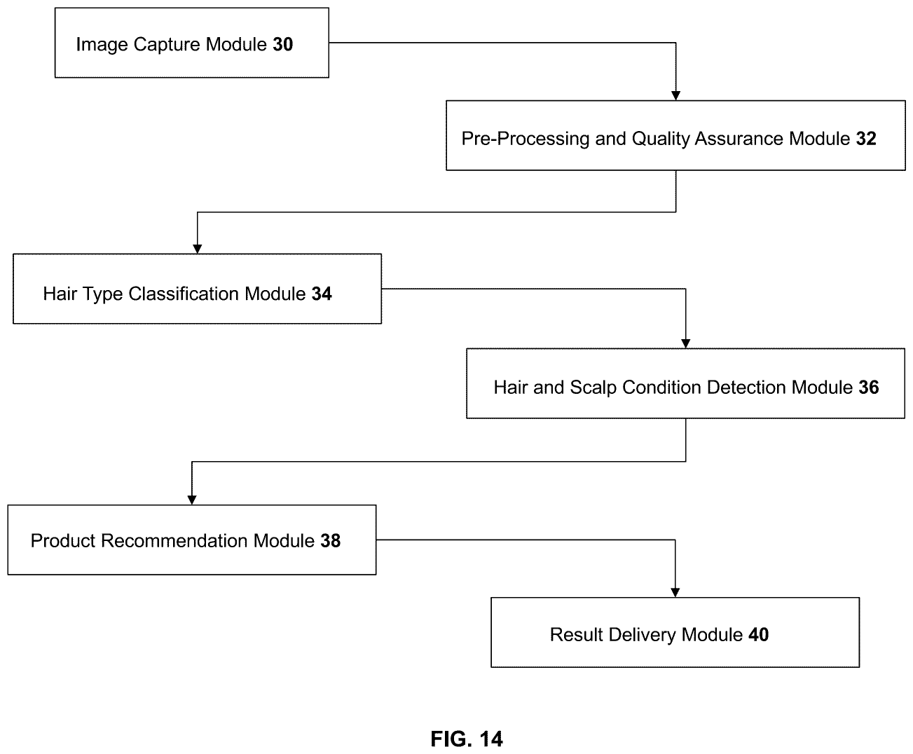

The following provides a non-limiting Example and further description of a non-limiting embodiment of the hair analysis system of the present invention. In this Example, the hair analysis system is preferably integrated into a cloud-connected pipeline as a set of inter-connected computing modules. More specifically, in this Example, the system comprises an image capture module 30, a pre-processing and quality assurance module 32, a hair type classification module 34, a hair and scalp condition detection module 36, a product recommendation module 38 (engine), and a result delivery module 40 (FIG. 14).

In this Example, the invention provides that the image capture module 30 includes and/or communicates with a digital camera (e.g., a camera integrated into a mobile device, tablet, or dedicated imaging station). The image capture module 30 is responsible for capturing a high-resolution image of a subject's hair and scalp, as described herein. The image capture module 30 may further harvest various types of metadata, such as lighting conditions, focal length, and orientation to assist the system with pre-processing and quality scoring functions. The pre-processing and quality assurance module 32 is configured to then normalize and impart color consistency within the image of the subject's hair—and, preferably, is further configured to carry out histogram equalization steps and background removal (e.g., using a pre-trained U²-Net segmentation model to isolate hair regions from non-hair areas). The invention provides that an algorithm may be employed by the pre-processing and quality assurance module 32 to evaluate and record image sharpness, lighting, and occlusion parameters. If the pre-processing and quality assurance module 32 determines that the image does not satisfy certain minimally acceptable criteria, the system may be configured to issue a substandard image notification to the user, asking the user to capture a new image (or a new set of images) of his/her hair.

In this Example, the hair type classification module 34 includes a fine-tuned EfficientNet-B4 convolutional neural network, which is configured to process the segmented hair image for the purpose of classifying the subject's hair into one of a plurality of classes, e.g., Type 1: Straight; Type 2: Wavy; Type 3: Curly; or Type 4: Coily. The invention provides that such classification output will preferably include a confidence score for validation and potential manual override. The hair image is then passed to the hair and scalp condition detection module 36, which utilizes a hybrid architecture that combines Vision Transformers (ViT) for global texture patterns and a mask R-CNN segmentation head to detect specific hair conditions, such as frizz level, split ends, oiliness, dryness, dandruff, thinning, and hair density. In such embodiments and non-limiting Example, each detected condition is then assigned a severity score and mapped to product requirement attributes.

The system is configured to then call the product recommendation module 38 that utilizes a rules-based and collaborative filtering hybrid model (matrix factorization and content-based filtering) to map (i) classified hair types and detected hair conditions to (ii) the curated products listed within the product database 14 described herein. The invention provides that hair care products are preferably tagged with various attributes, such as weight, hydration level, chemical composition, and active ingredients. The system's product recommendations are ranked based on, for example, hair condition match scores, past user preference data, and real-time inventory availability.

Next, the result delivery module 40 produces and conveys the final system output. Such output includes the hair type classification (Type 1-Type 4) with a corresponding explanation for such classification. The output may further include a hair condition detection summary with severity scores. Importantly, the output also includes a ranked list of product recommendations with corresponding images and purchase links. The system output may be rendered in a mobile application interface with optional API delivery for third-party integration.

In this Example, a user engages with the system by launching a mobile application and positions his/her head within an on-screen guide. The camera within the mobile device 22 captures three high-resolution images (front, side, and crown sides of the user's head). The images are then transferred to the cloud server 10 and processor 12 via secure APIs for pre-processing. The segmentation process described above removes unnecessary background from the image and extracts a hair-focused region (i.e. the focused excerpt 20 discussed above). The hair type classification module 34 then outputs a classification, e.g., “Type 3: Curly” with 94% confidence. The hair and scalp condition detection module 36 then identifies a hair/scalp condition, such as “moderate dryness” and “low frizz.” The product recommendation module 38 then matches such hair attributes to a lightweight hydrating shampoo and leave-in conditioner. The results are presented to the user with hyperlinked product images, which are preferably returned to the user within 3 seconds.

The system of this non-limiting Example provides several advantages. Specifically, the system provides precision segmentation through the use of deep learning segmentation (U²-Net), which ensures hair analyses are not affected by background interference. The system provides multi-model fusion through a combination of EfficientNet and Vision Transformers that enables simultaneous classification and fine-grained condition detection. The system provides dynamic recommendation mapping that adapts in real-time to detect attributes and product availability. The system further provides scalable architecture, with the camera-to-cloud pipeline supporting real-time inference capability that can process thousands of concurrent image submissions. In addition, the system provides feedback-driven improvements by incorporating user acceptance/rejection of product recommendations that are logged for continuous retraining of classification and recommendation models.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

We claim:

1. A hair analysis system, which comprises a server and a processor that are configured to receive a digital image of a subject's hair, wherein the server and processor are configured to:
(a) identify a hair classification of the subject's hair based on the digital image;
(b) communicate said hair classification to the subject; and
(c) communicate one or more recommendations to the subject, wherein the one or more recommendations identify one or more hair care products that are optimized for the subject's hair classification.

2. The hair analysis system of claim 1, wherein the hair classification is selected by the system from a plurality of predefined hair classification options.

3. The hair analysis system of claim 1, wherein the system is further configured to identify a second digital image that the subject may, optionally, capture and transmit to the system for analysis.

4. The hair analysis system of claim 1, wherein the system is configured to communicate the one or more recommendations to the subject based on (a) the hair classification and (b) the geographical location, weather conditions, and demographic data that pertain to the subject.

5. The hair analysis system of claim 1, wherein the system further comprises a database and a data storage facility that are configured to receive, record, and make accessible to the subject the digital image, hair classification, and the one or more recommendations.

6. The hair analysis system of claim 4, wherein the system is configured to communicate the one or more recommendations to the subject based on feedback submitted to the system from third-party subjects having hair classifications that match the hair classification of the subject.

7. The hair analysis system of claim 6, wherein the feedback includes assessments submitted by the third-party subjects regarding the one or more recommendations.

8. The hair analysis system of claim 1, which further comprises a computing device that is configured to capture the digital image; transmit the digital image to the system;
receive and display the hair classification to the subject; and receive and display the one or more recommendations to the subject.

9. The hair analysis system of claim 1, wherein the hair care products include shampoos, conditioners, gels, coloring agents, and/or sprays that are suitable for the subject's hair classification.

10. The hair analysis system of claim 1, wherein the hair care products are selected and identified by the system from a plurality of optional hair care products, wherein the plurality of optional hair care products are provided by third-party merchants.

11. The hair analysis system of claim 10, wherein the third-party merchants submit a fee to the system to have its hair care products listed within the plurality of optional hair care products.

12. The hair analysis system of claim 10, wherein the third-party merchants submit bids to the system to have its hair care products listed within the plurality of optional hair care products.

13. The hair analysis system of claim 1, wherein the server is configured to perform data augmentation techniques to produce a set of training images for the system to use for creating a deep learning model, wherein the data augmentation techniques produce variations of each digital image by automatically resizing each digital image, applying a random rotation of up to 10-degrees to each digital image, and constantly adjusting brightness and contrast filters applied to each digital image to amplify a number of digital images within the set of training images.
